(19) United States
(12) Patent Application Publication
(10) Pub. No.: US 2016/0010787 A1
(43) Pub. Date: Jan. 14, 2016

(54) EXPANSION JOINT FOR CONNECTING AN EXHAUST COLLECTOR OF AN ENGINE TO A DUCT SYSTEM

(71) Applicant: Solar Turbines Incorporated, San Diego, CA (US)

(72) Inventor: Gino H. Granda, Chula Vista, CA (US)

(21) Appl. No.: 14/325,402

(22) Filed: Jul. 8, 2014

(51) Int. Cl. F16L 59/21; F16L 23/14; F16L 25/12; F16L 23/16

(52) U.S. Cl. CPC F16L 59/21; F16L 23/16; F16L 23/14; F16L 25/12

(57) ABSTRACT

An expansion joint for connecting an exhaust collector of an engine to a duct system includes an upper frame, a lower frame, a resilient member, and a fabric membrane. The upper frame is formed from a plurality of first members in which ends of adjacent first members are releasably coupled to each other. The lower frame is disposed in a spaced-apart relation to the upper frame. The lower frame is formed from a plurality of second members in which ends of adjacent second members are releasably coupled to each other. The resilient member is disposed between mutually coupled ends of the first members and between mutually coupled ends of the second members. The resilient member is configured to elastically deform in response to a variation in the lengths of the first and the second members. The fabric membrane is affixed to an outer periphery of the upper and lower frames.

### TECHNICAL FIELD

The present disclosure generally relates to an expansion joint for connecting an exhaust collector of an engine to a duct system. More particularly, the present disclosure relates to an expansion joint having frames that are configured to resist cracking upon thermal expansion.

### BACKGROUND

Expansion joints may be used to fluidly connect an exhaust collector of an engine to a duct system. Typically, expansion joints may include one or more frames that are formed by welding elongated sections or members at their corners. For reference, U.S. Pat. No. 4,848,803 (hereinafter '803 patent) relates to expansion joints for use in exhaust systems. The expansion joints disclosed by the '803 patent includes frame members that are welded to each other. As such, welding the elongated sections or members may impart a rigid and unitary construction to the frame.

However, during operation of the engine, the frames may be exposed to thermal effects or encounter thermal gradients. Under such operating conditions, the welded frames may be unable to expand and/or contract due to its rigid and unitary type of construction. Moreover, the frame may tend to expand and cause the elongated sections or members to experience undue stress. In some cases, such tendency to expand may cause the elongated members or sections to crack at the weld joints.

### SUMMARY OF THE DISCLOSURE

In one aspect of the present disclosure, an expansion joint for connecting an exhaust collector of an engine to a duct system includes an upper frame, a lower frame, a resilient member, and a fabric membrane. The upper frame is formed from a plurality of first members in which ends of adjacent first members are releasably coupled to each other. The lower frame is disposed in a spaced-apart relation to the upper frame. The lower frame is formed from a plurality of second members in which ends of adjacent second members are releasably coupled to each other. The resilient member is disposed between mutually coupled ends of the first members and between mutually coupled ends of the second members. The resilient member is configured to elastically deform in response to a variation in the lengths of the first and the second members. The fabric membrane is affixed to an outer periphery of the upper and lower frames.

In another aspect of the present disclosure, an expansion joint for connecting an exhaust collector of an engine to a duct system includes an upper frame, a lower frame, a resilient member, and a shield liner. The upper frame is formed from a plurality of first members in which ends of adjacent first members are releasably coupled to each other. The lower frame is disposed in a spaced-apart relation to the upper frame. The lower frame is formed from a plurality of second members in which ends of adjacent second members are releasably coupled to each other. The resilient member is disposed between mutually coupled ends of the first members and between mutually coupled ends of the second members. The resilient member is configured to elastically deform in response to a variation in the lengths of the first and the second members. The shield liner is affixed to an inner periphery of the lower frame.

In another aspect of the present disclosure, a method for manufacturing an expansion joint includes providing a plurality of first members, positioning a resilient member between ends of mutually adjacent first members, and releasably coupling the ends of mutually adjacent first members to form an upper frame. The method further includes providing a plurality of second members, positioning a resilient member between ends of mutually adjacent second members, and releasably coupling the ends of mutually adjacent second members to form a lower frame. Further, the method includes affixing a fabric membrane to an outer periphery of the upper frame and the lower frame, and affixing a shield liner to an inner periphery of the lower frame.

Other features and aspects of this disclosure will be apparent from the following description and the accompanying drawings.

### BRIEF DESCRIPTION OF THE DRAWINGS

FIG. 1 is a side perspective view of an exemplary gas turbine engine employing an expansion joint in accordance with an embodiment of the present disclosure;

FIG. 2 is a partial breakaway view of an exhaust coupler and a duct system showing the expansion joint of FIG. 1;

FIG. 3 is a front perspective view of the expansion joint;

FIG. 4 is a sectional view of the expansion joint taken along section line A-A′ of FIG. 3;

FIG. 5 is a front perspective view of the expansion joint showing resilient members disposed between adjacent first frame members and between adjacent second frame members respectively; and

FIG. 6 is a flowchart of a method for manufacturing an expansion joint.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

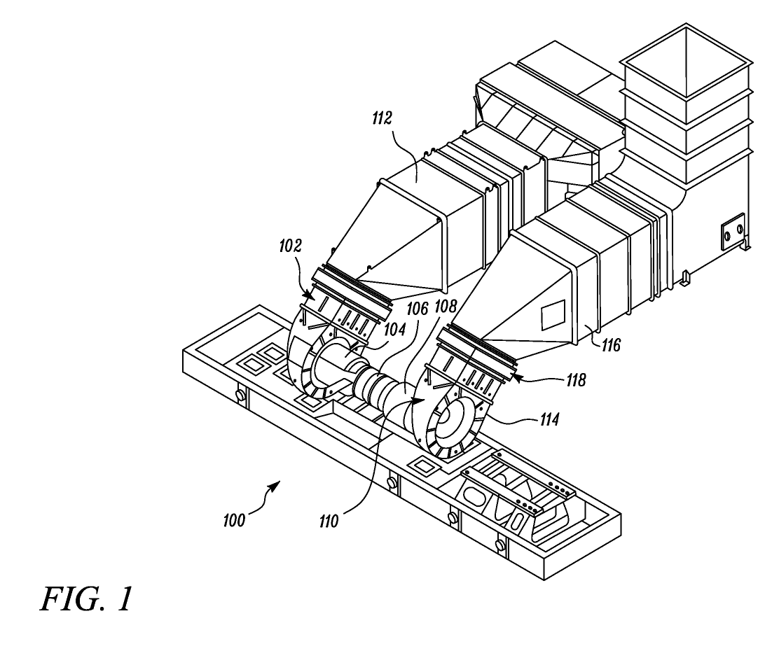

FIG. 1 shows a side view of an exemplary gas turbine engine 100 in accordance with an embodiment of the present disclosure. However, in alternative embodiments, other types of engines known in the art may be suitably employed in lieu of the gas turbine engine 100 of FIG. 1. Some examples of engines that may be optionally used in place of the gas turbine engine 100 may include, but are not limited to, reciprocating engines, rotary engines or any other types of engines known in the art.

Besides engines, the present disclosure may also be implemented in other structures typically used in various industrial applications. These structures may vary depending upon the associated application. For example, the structures may be a furnace and an exhaust ducting in which embodiments of the present disclosure can be beneficially implemented to relieve thermal expansion and allow relative movement of such structures. Therefore, although the present disclosure is explained in conjunction with the gas turbine engine 100, one of ordinary skill in the art will acknowledge that embodiments of the present disclosure can be similarly applied to or implemented with other suitable structures known in the art.

Referring to FIG. 1, the gas turbine engine 100 includes an inlet system 102, a compressor system 104, a combustor system 106, a turbine system 108, and an exhaust system 110. The inlet system 102 is coupled to an inlet duct system 112 that is configured to draw and supply air from the atmosphere to the compressor system 104. The compressor system 104 may compress the supplied air and operatively provide the compressed air to various components of the combustor system 106 and the turbine system 108, the compressed air also serving purposes in the gas turbine engine 100 such as, but not limited to, venting, and escaping through the exhaust system 110.

The combustor system 106 may include multiple injectors, and combustors (not shown) operatively connected to the injectors. The injectors may supply a mixture of fuel and air to the combustors. The combustors combust the mixture of fuel and air to generate energy. This energy may be utilized to drive the turbine system 108 which may in turn use some part of the energy in driving the compressor system 104 while concurrently using the remaining part of the energy to do work.

The exhaust system 110 is coupled to the turbine system 108. Moreover, the exhaust system 110 includes an exhaust collector 114 disposed in fluid communication with a duct system 116 with the help of an expansion joint 118. For purposes of clarity, the duct system 116 associated with the exhaust collector 114 will hereinafter be referred to as ‘the outlet duct system’ and designated with the same reference numeral ‘116’. The present disclosure relates to the expansion joint 118 that connects the exhaust collector 114 to the outlet duct system 116.

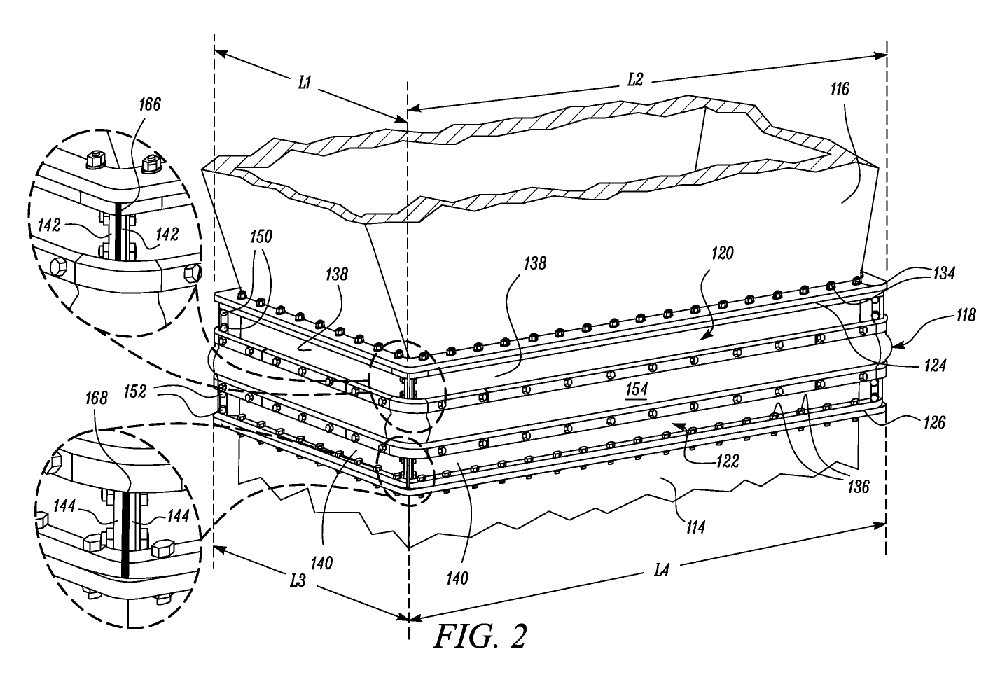

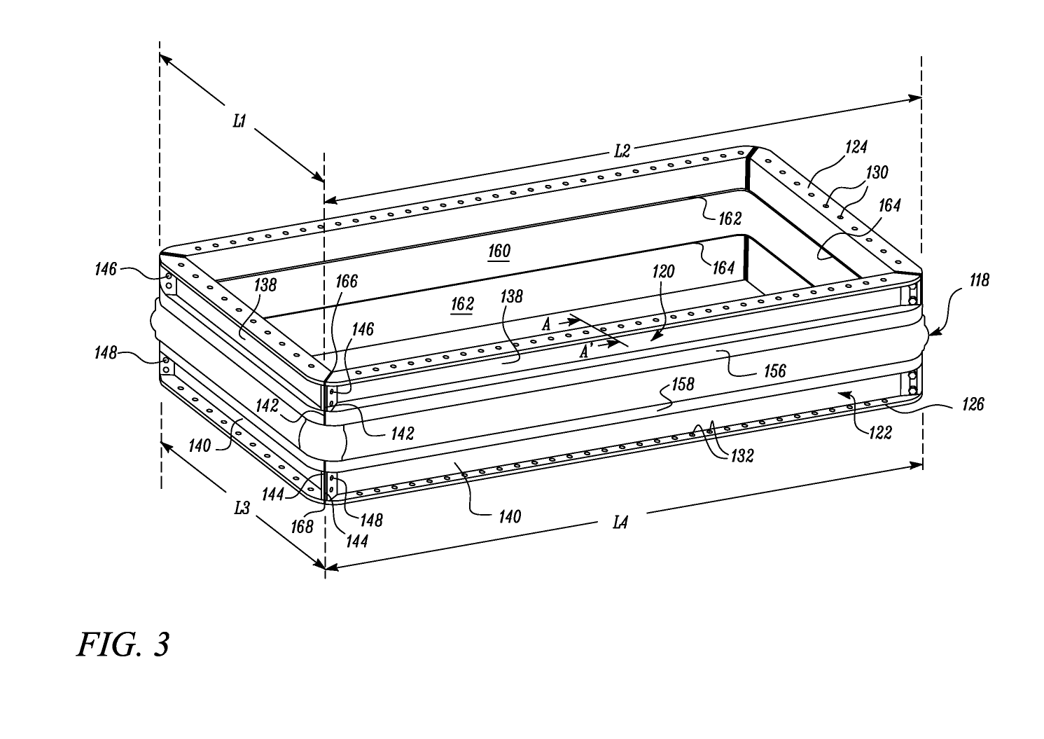

As shown in FIGS. 2 and 3, the expansion joint 118 includes an upper frame 120, and a lower frame 122. As shown, a shape of the upper and lower frame 122 is rectangular while the upper and lower frames 120, 122 have relatively similar sizes. However, in alternative embodiments, the upper and lower frames 120, 122 of the expansion joint 118 could be optionally configured to have dissimilar sizes and/or shapes. Moreover, a person having ordinary skill in the art will acknowledge that the shapes and sizes of the upper and lower frames 120, 122 may vary depending on the shapes and sizes of the outlet duct system 116 and the exhaust collector 114. As such, the shapes and sizes of the upper and lower frames 120, 122 may beneficially be configured to correspond with the shapes and sizes of the outlet duct system 116 and the exhaust collector 114 respectively, and hence, allow fitment with the outlet duct system 116 and the exhaust collector 114.

Moreover, an upper end 124 of the upper frame 120 and a lower end 126 of the lower frame 122 may define a plurality of holes 130, 132 respectively therethrough. These holes 130, 132 may be configured to receive one or more fasteners 134, 136 so that the upper frame 120 may be releasably fastened to the outlet duct system 116 while the lower frame 122 may be releasably fastened to the exhaust collector 114.

With continued reference to FIGS. 2 and 3, the upper frame 120 is formed from a plurality of first members 138 in which ends 142 of adjacent first members 138 are releasably coupled to each other. The lower frame 122 is disposed in a spaced-apart relation to the upper frame 120. The lower frame 122 is formed from a plurality of second members 140 in which ends 144 of adjacent second members 140 are releasably coupled to each other.

The ends 142, 144 of mutually adjacent first members 138 and mutually adjacent second members 140 define axially aligned holes 146, 148 therein. These holes 146, 148 may be suitably sized and/or shaped to receive fasteners 150, 152 therein. As shown in FIG. 2, the fasteners 150, 152 include a bolt and nut arrangement. However, in alternative embodiments, the fasteners 150, 152 may include rivets, screws, or other types of fastening systems that are commonly known in the art for accomplishing a releasable coupling between two components or structures.

As shown in FIG. 3, the expansion joint 118 may further include a fabric membrane 154 affixed to an outer periphery 156, 158 of the upper frame 120 and the lower frame 122 respectively. This fabric membrane 154 may be flexible and hence, allow movement of the upper and lower frames 120, 122 relative to each other. In one embodiment, the fabric membrane 154 may be Polytetrafluoroethylene [PTFE] (commonly known as Teflon®). However, it may be noted that other suitable materials or combination of materials may be alternatively employed in lieu of the PTFE disclosed herein.

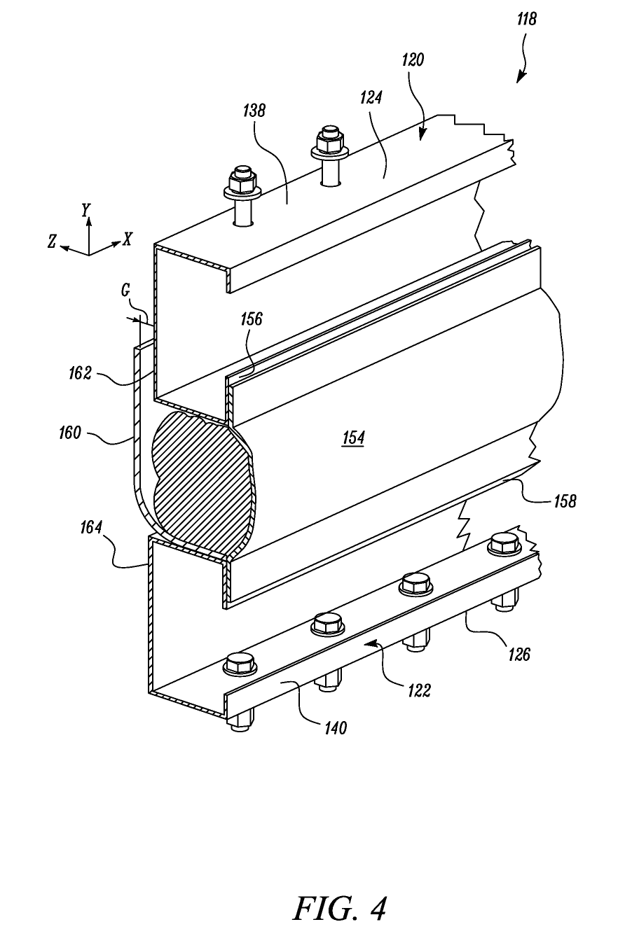

Moreover, the expansion joint 118 may additionally include a shield liner 160 affixed to an inner periphery 164 of the lower frame 122. The shield liner 160 may be formed or made from a heat resistant material such as, but not limited to, high temperature rated steel for e.g., 321 grade SS [Stainless Steel]. Moreover, as shown in the enlarged cross-sectional view of FIG. 4 (cross-section taken along line A-A′ of FIG. 3), a size of the shield liner 160 may be configured so as to define a gap G with an inner periphery 162 of the upper frame 120. This gap G may be beneficially provided to allow thermal expansion and/or relative movement between the upper frame 120 and the lower frame 122 in the X, Y, and Z axes during operation.

Although some examples of the fabric membrane 154 and the shield liner 160 have been disclosed herein, it should be noted that a type of fabric membrane 154 and/or shield liner 160 is exemplary in nature and hence, non-limiting of this disclosure. One of ordinary skill in the art will appreciate that the type of fabric membrane 154 and/or shield liner 160 may vary from one application to another depending on specific requirements of an application.

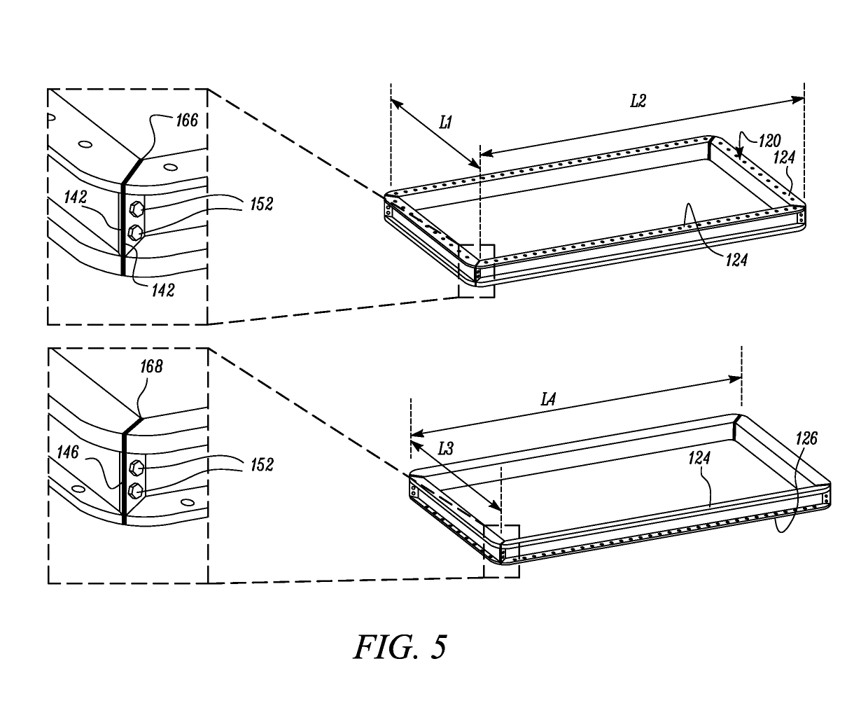

Referring to FIGS. 3 and 5, the expansion joint 118 further includes resilient members 166, 168 disposed between mutually coupled ends 142, 144 of the first members 138 and the second members 140 (One resilient member 166, 168 is visible in each of the frames 120, 122 in the perspective view of FIG. 5).

The resilient members 166, 168 are configured to elastically deform in response to a variation in the lengths L1, L2 and L3, L4 of the first members 138 and/or the second members 140 respectively. It is known that during operation of any engine, heat may be radiated into components that are associated with or lie within a vicinity of the engine. Similarly, the expansion joint 118 disclosed herein may be subject to the heat radiated by the gas turbine engine 100 and/or from the exhaust gases flowing within the expansion joint 118. As the expansion joint 118 may experience thermal gradients, such thermal gradients may tend to influence the expansion joint 118 to expand and/or contract. At this point, the first members 138 and/or the second members 140 may vary in length in response to the thermal gradients while the resilient members 166, 168 may vary in volume to compensate for the expansion or contraction of the first and second members 138, 140.

In an embodiment, the resilient members 166, 168 may be made of an elastomeric material. However, in other embodiments, the resilient members 166, 168 may optionally be formed from a polymer, a metal, a resin, a ceramic, a composite material, or a combination of the above-mentioned materials. It is also envisioned that in addition to the ability to elastically deform, the resilient members 166, 168 may also be made of a heat-resistant material such that the resilient members 166, 168 may withstand high temperatures of the exhaust flowing through the expansion joint 118. Therefore, one of ordinary skill in the art will acknowledge that although some exemplary types of materials have been disclosed herein, the resilient members 166, 168 may be made from any suitable material depending upon specific requirements of an application.

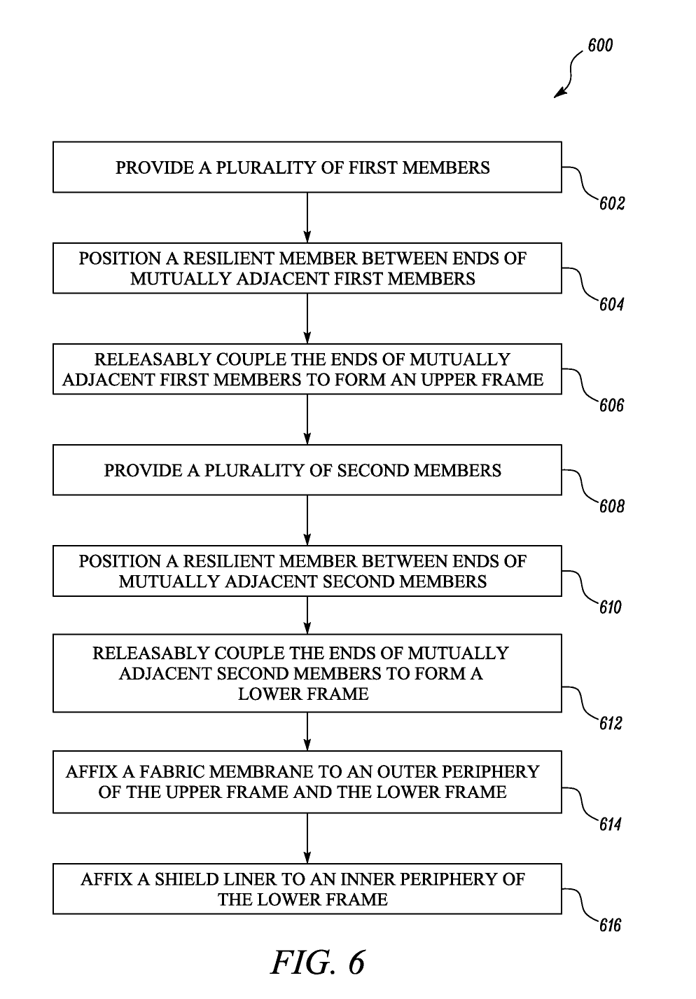

FIG. 6 is a method 600 for manufacturing the expansion joint 118. At step 602, the method 600 includes providing the plurality of first members 138. At step 604, the method further includes positioning the resilient members 166 between ends 142 of mutually adjacent first members 138. At step 606, the method 600 further includes releasably coupling the ends 142 of mutually adjacent first members 138 to form the upper frame 120.

Moreover, at step 608, the method 600 further includes providing the plurality of second members 140. At step 610, the method 600 further includes positioning the resilient members 166 between ends 144 of mutually adjacent second members 140. At step 612, the method 600 further includes releasably coupling the ends 144 of mutually adjacent second members 140 to form the lower frame 122.

Further, at step 614, the method 600 includes affixing the fabric membrane 154 to the outer periphery 156 of the upper frame 120 and the outer periphery 158 of the lower frame 122. Furthermore, at step 616, the method 600 further includes affixing the shield liner 160 to the inner periphery 164 of the lower frame 122.

Although the frames 120, 122 disclosed herein are of a rectangular shape, it should be noted that embodiments of the present disclosure are equally applicable to frames of various shapes such as, but not limited to, a triangular shape, a pentagonal shape, a hexagonal shape, or other polygonal and/or multi-sided shapes commonly known to one skilled in the art.

Various embodiments disclosed herein are to be taken in the illustrative and explanatory sense, and should in no way be construed as limiting of the present disclosure. All directional references (e.g., inward, outward, radial, upper, lower, upward, downward, left, right, leftward, rightward, L.H.S, R.H.S, top, bottom, above, below, vertical, horizontal, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure has applicability in preventing undue stresses and/or cracking in frames of an expansion joint. As embodiments of the present disclosure allow a manufacturer to produce expansion joints having a flexible construction and hence, vary in volume under the effect of thermal gradients, the frame members have a decreased possibility of experiencing undue stresses and/or experiencing cracks therein. Therefore, with use of the present disclosure, a service life of the expansion joints may be prolonged. Moreover, with use of the expansion joint 118 disclosed herein, costs incurred with repair or replacement of previously known expansion joints may be offset or mitigated.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An expansion joint for connecting an exhaust collector of an engine to a duct system, the expansion joint comprising:
an upper frame formed from a plurality of first members, wherein ends of adjacent first members are releasably coupled to each other;
a lower frame disposed in a spaced-apart relation to the upper frame, the lower frame formed from a plurality of second members, wherein ends of adjacent second members are releasably coupled to each other;
a resilient member disposed between mutually coupled ends of the first members and between mutually coupled ends of the second members, the resilient member configured to elastically deform in response to a variation in the lengths of the first and second members; and
a fabric membrane affixed to an outer periphery of the upper frame and the lower frame.

2. The expansion joint of claim 1 further comprising a shield liner affixed to an inner periphery of the lower frame.

3. The expansion joint of claim 2, wherein the shield liner together with an inner periphery of the upper frame is configured to define a gap therebetween.

4. The expansion joint of claim 1, wherein the ends of mutually adjacent first members and mutually adjacent second members define axially aligned holes therein.

5. The expansion joint of claim 4 further including fasteners that are configured to register with the axially aligned holes defined in the ends of the mutually adjacent first members and the mutually adjacent second members.

6. The expansion joint of claim 5, wherein the fasteners are at least one of a bolt and nut arrangement, rivets, and screws.

7. The expansion joint of claim 1, wherein the resilient member is made from at least one of an elastomer, a polymer, a metal, a resin, a ceramic, a composite material, and any combinations thereof.

8. An engine including:
an exhaust collector;
a duct system disposed in a spaced apart relation to the exhaust collector; and
employing the expansion joint of claim 1 to connect the exhaust collector to the duct system, wherein the upper frame is configured to connect to the duct system, and the lower frame is configured to connect to the exhaust collector.

9. The engine of claim 8, wherein the engine is a gas turbine engine.

10. An expansion joint for connecting an exhaust collector of an engine to a duct system, the expansion joint comprising:
an upper frame formed from a plurality of first members, wherein ends of adjacent first members are releasably coupled to each other;
a lower frame disposed in a spaced-apart relation to the upper frame, the lower frame formed from a plurality of second members, wherein ends of adjacent second members are releasably coupled to each other;
a resilient member disposed between mutually coupled ends of the first members and between mutually coupled ends of the second members, the resilient member configured to elastically deform in response to a variation in the lengths of the first and second members; and
a shield liner affixed to an inner periphery of the lower frame.

11. The expansion joint of claim 10 further comprising a fabric membrane affixed to an outer periphery of the upper frame and the lower frame.

12. The expansion joint of claim 10, wherein the shield liner together with an inner periphery of the upper frame is configured to define a gap therebetween.

13. The expansion joint of claim 10, wherein the ends of mutually adjacent first members and mutually adjacent second members define axially aligned holes therein.

14. The expansion joint of claim 13 further including fasteners that are configured to register with the axially aligned holes defined in the ends of the mutually adjacent first members and the mutually adjacent second members.

15. The expansion joint of claim 14, wherein the fasteners are at least one of a bolt and nut arrangement, rivets, and screws.

16. The expansion joint of claim 10, wherein the resilient member is made from at least one of an elastomer, a polymer, a metal, a resin, a ceramic, a composite material, and any combinations thereof.

17. A method for manufacturing an expansion joint, the method comprising:
providing a plurality of first members;
positioning a resilient member between ends of mutually adjacent first members;
releasably coupling the ends of mutually adjacent first members to form an upper frame;
providing a plurality of second members;
positioning a resilient member between ends of mutually adjacent second members;
releasably coupling the ends of mutually adjacent second members to form a lower frame;
affixing a fabric membrane to an outer periphery of the upper frame and the lower frame; and
affixing a shield liner to an inner periphery of the lower frame.

18. The method of claim 17 further including defining axially aligned holes in the ends of mutually adjacent first members and mutually adjacent second members.

19. The method of claim 18 further including positioning one or more fasteners within the axially aligned holes defined in the ends of the mutually adjacent first members and the mutually adjacent second members.

20. The method of claim 17, wherein the resilient member is made from at least one of an elastomer, a polymer, a metal, a resin, a ceramic, a composite material, and any combinations thereof.
